(19) United States
(12) Patent Application Publication
(10) Pub. No.: US 2018/0133961 A1
(43) Pub. Date: May 17, 2018

(54) APPARATUS FOR ADDITIVE MANUFACTURING OF THREE-DIMENSIONAL OBJECTS

(71) Applicant: CL SCHUTZRECHTSVERWALTUNGS GMBH, Lichtenfels (DE)

(72) Inventors: Jens STAMMBERGER, Rodental (DE); Daniel WINIARSKI, Bad Staffelstein (DE)

(73) Assignee: CL SCHUTZRECHTSVERWALTUNGS GMBH, Lichtenfels (DE)

(21) Appl. No.: 15/812,668

(22) Filed: Nov. 14, 2017

(30) Foreign Application Priority Data
Nov. 14, 2016 (DE) 102016121782.4

(51) Int. Cl. B29C 64/25; B29C 64/153; B22F 3/105; B33Y 30/00; B33Y 10/00

(52) U.S. Cl. CPC B29C 64/25; B29C 64/153; B29C 64/268; B33Y 30/00; B33Y 10/00; B22F 3/1055

(57) ABSTRACT

An apparatus (1) for additive manufacturing of three-dimensional objects (2) by successive, selective layer-by-layer exposure and thus solidification of construction material layers of a construction material (3) that can be solidified by means of an energy beam (6), comprising an outer housing construction (4) comprising several housing walls (4a-4f), wherein within the housing construction (4) several functional components of the apparatus (1) are arranged or formed, wherein at least one housing wall (4a-4f) is formed as a sheet metal part or comprises at least one sheet metal part.

The invention relates to an apparatus for additive manufacturing of three-dimensional objects by successive, selective layer-by-layer exposure and thus solidification of construction material layers of a construction material that can be solidified by an energy beam, comprising an outer frame construction comprising one or more frame construction elements, wherein within the housing construction several functional components of the apparatus are arranged or formed.

Respective apparatuses for additive manufacturing of three-dimensional objects, e.g. in the form of apparatuses for performing selective laser sintering methods or selective laser melting methods, are per se known. Respective apparatuses comprise an outer housing construction comprising several housing walls, within which several functional components of the apparatus, i.e., for example, an exposure device, a coating device, etc. are arranged or formed.

Until now, it has been common that the housing construction is formed as a frame construction comprising several profile-like or profile-shaped frame construction elements, to which separate covering elements are attached. The individual frame construction elements forming the frame construction are attached to each other in a certain spatial arrangement. Overall, the design of a respective frame construction is comparatively complex both in structural and in manufacturing terms.

The invention is based on the object of providing, especially in terms of a housing construction that is built in a simplified manner both in structural and in manufacturing terms, an improved apparatus for additive manufacturing of three-dimensional objects.

The object is solved by an apparatus for additive manufacturing of three-dimensional objects according to claim 1. The dependent claims relate to possible embodiments of the apparatus.

The apparatus (“apparatus”) described herein is provided for additive manufacturing of objects, i.e., for example, technical components or technical component groups, by successive, selective layer-by-layer exposure and thus successive, selective layer-by-layer solidification of construction material layers of a construction material that can be solidified. The construction material can especially be a particulate or powdered metal material, plastic material, and/or ceramic material. The selective solidification of respective construction material layers to be selectively solidified is carried out based on object-related construction data. Respective construction data describe the geometric structural design of the respective object to be additively manufactured and can, for example, include “sliced” CAD data of the object to be additively manufactured. The apparatus can be formed as an SLM apparatus, i.e. as an apparatus for performing selective laser melting methods (SLM methods), or as an SLS apparatus, i.e. as an apparatus for performing selective laser sintering methods (SLS methods).

The apparatus comprises the functional components typically required for performing additive construction processes. This especially involves a coating device provided for forming construction material layers to be selectively solidified (in the construction plane of the apparatus) and an exposure device provided for the selective exposure of construction material layers to be selectively solidified (in the construction plane of the apparatus). The coating device can comprise several components, i.e., for example, a coating element comprising an, especially blade-shaped, coating tool, and a guiding device for guiding the coating element along a defined trajectory. The exposure device can also comprise several components, i.e., for example, a beam generation device for generating an energy or laser beam, a beam deflection device (scanner device) for deflecting an energy or laser beam generated by the beam generation device to a section to be exposed of a construction material layer to be selectively solidified, and various optical elements, such as filter elements, objective elements, lens elements, etc.

The apparatus comprises an outer housing or frame construction (“housing construction”). The housing construction typically forms a (closed) housing or covering construction of the apparatus. The housing construction thus (essentially) defines the outer design of the apparatus.

The housing construction comprises several housing walls or housing wall portions. The housing walls or the housing wall portions limit a housing construction interior space. In the housing construction interior space several functional components of the apparatus are arranged or formed, i.e., for example, a process chamber, the coating device typically arranged in the process chamber, and the exposure device typically arranged or formed on the process chamber.

Respective housing walls can, especially in the example of an (essentially) cuboid-like or cuboid-shaped housing construction, i.e. a housing construction having a (significantly) quadrangular base or cross-sectional shape, form a front wall forming a front side of the housing construction, a rear wall arranged opposite said front wall, forming a rear side of the housing construction, a first side wall extending (rect)angularly between the front and rear walls, a second side wall arranged opposite the first side wall between the front and rear walls, extending (rect)angularly to those, a ceiling wall of the housing construction, or a bottom wall of the housing construction.

At least one housing wall, i.e. possibly all housing walls, is or are formed by sheet metal parts. The sheet metal parts similarly form the (closed) housing or covering construction of the apparatus. The housing construction of the apparatus described herein thus comprises no frame construction comprising several profile-like frame construction elements, to which separate covering elements are attached, but at least partially, especially completely, consists of sheet metal parts. The housing construction is thus built in a simplified manner both in structural and in manufacturing terms; an improved apparatus is provided. The sheet metal parts typically have a plane geometric-structural design. Specifically, the sheet metal parts can, e.g., have a quadrangular or rectangular geometric-structural plane design. The dimensions of the sheet metal parts are typically selected in terms of the dimensions of the housing wall(s) formed by them; typically, the dimensions of the sheet metal parts thus correspond to the dimensions of the housing walls respectively formed by them.

The structural properties of the sheet metal parts allow a supporting function for the housing construction. It is basically not necessary to provide further supporting constructional elements for forming the housing construction. As described further below, in individual cases it can, however, be required to (mechanically) reinforce or stiffen the sheet metal parts or the housing construction by suitable (mechanical) reinforcement elements or stiffening elements.

Respective sheet metal parts can, e.g., be formed of a steel sheet or a stainless steel sheet. The wall thickness (thickness) of a respective sheet metal part is typically in a range between 1 and 10 mm, especially between 2 and 6 mm. Of course, upwards and downwards exceptions are possible. Especially it is conceivable that a sheet metal part has sheet metal part portions of different thicknesses, which can be realized, e.g., by different wall thicknesses or a multi-layered design of a sheet metal part; this way, the structural properties of the sheet metal part can specifically be manipulated.

Respective sheet metal parts can comprise one or more attachment interfaces, which are provided for attaching at least one functional component to the sheet metal part. Respective attachment interfaces can enable a form-locked and/or force-locked and/or substance attachment of a functional component to the sheet metal part. An attachment interface enabling a force-locked attachment of the functional component to the sheet metal part can, e.g., be or comprise a bore, especially a threaded hole, which can be penetrated by a screw element. Eligible form-locked attachment types are, e.g., clip attachments or locking attachments; eligible substance attachments are, e.g., adhesive joints, soldered joints, or welding joints.

At least two sheet metal parts adjacently arranged can directly be attached to each other in a form-locked and/or force-locked and/or substance attachment manner. The attachment of respective sheet metal parts to each other can thus be carried out by various form-locked and/or force-locked and/or substance attachment types enabling a detachable (in a damage-free and non-destructive manner) or a non-detachable attachment of respective sheet metal parts (in a damage-free and non-destructive manner). Reference to riveting attachments, clamp attachments, screw attachments, or push-in attachments as examples for form-locked and/or force-locked attachment types, and to adhesive joints, soldered joints, or welding joints as examples for substance attachments is only made exemplary.

At least two sheet metal parts adjacently arranged can also be indirectly, i.e. by interconnecting at least one assembly component, be attached to each other in a form-locked and/or force-locked and/or substance attachment manner. The sheet metal parts can each be attached to the assembly component and thus to each other in a fixed and stable arrangement and orientation. The assembly component can, e.g., be formed as assembly block or an assembly bracket. The assembly component has narrow tolerances such that sheet metal parts attached to each other by it are accurately positioned.

A respective assembly component can comprise at least one first attachment interface provided for attaching a first sheet metal part in a fixed and stable positioning to the assembly component, and at least one second attachment interface provided for attaching a second (or further) sheet metal part in a fixed and stable positioning to the assembly component. Respective first and second attachment interfaces can enable a form-locked and/or force-locked and/or substance attachment of a respective sheet metal part on the assembly component. The explanations above on the form-locked and/or force-locked and/or substance attachment types apply analogously.

A sheet metal part can be a stamped part/bent part that in manufacturing terms can be manufactured comparatively simply. Stamped parts/bent parts can be manufactured with narrow tolerances in different geometric-structural designs. In terms of the forming of a sheet metal part as a bent part, it applies that the sheet metal part can be bent two- or three-dimensionally.

A sheet metal part can comprise several sheet metal part portions, especially (rect)angular to each other. A first sheet metal part portion can form at least one part of a first housing wall or a first housing wall, and at least one other sheet metal part portion can form at least one part of at least one other housing wall or at least one other housing wall. Related to an (essentially) cuboid-like or cuboid-shaped design of the housing construction, a respective sheet metal part portion can form at least one part of the front, side, rear, ceiling, or bottom walls of the housing construction. Respective sheet metal parts can, e.g., have an angular base shape, i.e. an (essentially) L- or U-shaped base shape, wherein a respective sheet metal part portion forms a long or short leg of the L or the U. To this extent, a housing wall formed of a sheet metal part can also comprise several housing wall portions, especially angular to each other, wherein a respective housing wall portion forms at least one part of the front, side, or rear walls of the housing construction.

It was mentioned that it can be required to (mechanically) reinforce or stiffen the sheet metal parts or the housing construction by suitable (mechanical) reinforcement elements or stiffening elements. A respective sheet metal part can thus be formed with a reinforcing structure or stiffening structure, especially in the form of a bead structure comprising at least one bead. A reinforcing structure or stiffening structure can thus generally be formed by constructional elements for reinforcing or stiffening the sheet metal part, which are formed in the sheet metal part itself.

A reinforcement or stiffening of the sheet metal parts or the housing construction can alternatively or complementary also be realized by a reinforcement frame assigned to the housing construction. The reinforcement frame can be arranged or formed outside and/or within the housing construction, wherein the reinforcement frame abuts on at least one sheet metal part to be reinforced or to be stiffened or a housing wall to be reinforced or to be stiffened such that it has a reinforcing or stiffening effect on the sheet metal part. The reinforcement frame can be a component (group) serving the reinforcement or stiffening of sheet metal parts or the housing construction.

However, it is also conceivable that the or a reinforcement frame is formed by an, especially plate-like, process chamber wall element limiting the process chamber of the apparatus at the bottom, laterally, and at the ceiling. For example, the process chamber wall element laterally limiting the process chamber of the apparatus can serve to reinforce or to stiffen the housing construction. This can be realized by the process chamber wall element at least partially extending along a housing wall. A process chamber wall element limiting the process chamber at the bottom and comprising a construction plane, in which the actual selective layer-by-layer exposure and thus the solidification of construction material layers of construction material that can be solidified by means of an energy beam is carried out, can serve to reinforce or to stiffen the housing construction by being arranged or formed directly between two housing walls arranged opposite each other. This analogously applies to a process chamber wall element limiting the process chamber at the ceiling.

Further, it is conceivable that the or a reinforcement frame is formed by a portion of a control cabinet construction, in which electrical and/or electronic components of the apparatus are arranged or formed. Specifically, the reinforcement frame can be formed by a housing construction of the control cabinet, which serves as an (additional) reinforcement frame of the (additional) reinforcement or stiffening of the housing construction.

It is further conceivable that the or a reinforcement frame is formed by a user working surface, i.e. an area accessible for a user of the apparatus, on which the user can put down various objects, i.e., for example, a keyboard or another input device, via which input can be entered, especially regarding the operation of the apparatus. Specifically, a user working surface can be formed by a plate element, which serves as an (additional) reinforcement frame of the (additional) reinforcement or stiffening of the housing construction. The plate element is in a suitable manner attached to the housing construction such that a reinforcement or stiffening effect on the housing construction is produced.

The apparatus can comprise a process block that can be arranged or is arranged within the frame construction. The process block can also serve the reinforcement or stiffening of sheet metal parts or the housing structure. On and/or in the process block, several functional components of the apparatus can be arranged or formed. The process block can thus comprise one or more attachment interfaces, which are provided for attaching at least one functional component to the process block. Respective attachment interfaces can enable a form-locked and/or force-locked and/or substance attachment of a functional component to the process block. An attachment interface enabling a force-locked attachment of the functional component to the process block can, e.g., be or comprise a bore, especially a threaded hole, which can be penetrated by a screw element. Eligible form-locked attachment types are, e.g., clip attachments or locking attachments; eligible substance attachments are, e.g., adhesive joints, soldered joints, or welding joints. Apart from possible user or operating interfaces, such as an operating device communicating with a control device of the apparatus controlling the operation of the functional components for performing additive construction processes, e.g. in the form of a touch panel, and/or connecting elements, e.g. for connecting an external (electric) energy supply for certain functional components, when providing a corresponding process block no functional components need to be arranged or formed on the housing construction.

The process block along with the functional components arranged or formed on and/or in it constitutes (regarding the housing construction) a separate, i.e. movable especially independently from the housing construction, construction unit; the process block thus forms no component of the housing construction. The process block can be arranged within the housing construction such that it or the functional components arranged or formed on and/or in it are in no contact with the housing construction; consequently, it is conceivable that between the process block or the functional components arranged or formed on and/or in it, there is no direct mechanical contact. The process block or the functional components arranged or formed on and/or in it can thus be mechanically decoupled from the housing construction. Possible forces, vibrations, etc. brought into the housing construction cannot be transferred to the process block or the functional components arranged or formed on and/or in it, which is positively affecting the operation thereof.

Possible functional components arranged or formed on and/or in the process block are arranged on and/or in it in a positioning that can exactly be defined or is defined, i.e. arrangement and/or orientation. The process block forms the reference system for the defined spatial arrangement of the functional components arranged or formed on and/or in it. The process block has typically defined process block axes, which can form an, e.g. Cartesian, coordinate system of the process block. The process block can, in geometric-structural terms, be a comparatively simply built construction unit which can be manufactured with narrow tolerances, which is required to use the process block as a reference system for an accurate positioning of the functional components. Specifically, the process block can, e.g., be a milled part.

The process block as well as the functional components arranged or formed on and/or in it can form an assembly that can be preconfigured or is preconfigured and separately manageable. Thus it is possible to equip the process block with certain functional components and in such a way form an assembly that is preconfigured, separately manageable, i.e. especially transportable. In such a way, e.g. assembly, repair, or service tasks of the apparatus can be simplified.

The functional components can directly or indirectly, i.e., by interconnecting at least one assembly component, be arranged on and/or in the process block. In case of an indirect attachment of functional components, the functional components arranged on the process block can be attached to the process block by an assembly component that can be attached or is attached to the process block. The functional components can be attached in a fixed and stable arrangement and orientation to the assembly component; the assembly component can be attached in a fixed and stable arrangement and orientation to the process block. The assembly component can, e.g., be formed as assembly block or an assembly bracket. The assembly component has narrow tolerances such that functional components attached by it are accurately positioned.

A respective assembly component can comprise at least one first attachment interface provided for attaching a functional component in a fixed and stable positioning to the assembly component. A first attachment interface can enable a form-locked and/or force-locked and/or substance attachment of the functional component to the assembly component. A respective assembly component can comprise at least one second attachment interface provided for attaching the assembly component in a fixed and stable positioning to the process block. A second attachment interface can enable a form-locked and/or force-locked and/or substance attachment of the assembly component to the process block. An attachment interface enabling a force-locked attachment of the functional component to the assembly component can, e.g., be or comprise a bore that can be penetrated by a screw element; also, an attachment interface enabling a force-locked attachment of the assembly component to the process block can, e.g., be or comprise a bore, especially a threaded bore, which can be penetrated by a screw element. Form-locked or force-locked attachment types have been mentioned above. Although the positioning of the functional component(s) on the assembly component or the positioning of the assembly component on the process block is fixed and stable, it can be detachable (in a damage-free and non-destructive manner).

The process block can comprise a process block base body. The process block base body can limit the process chamber of the apparatus being a functional component. The process chamber of the apparatus can thus be formed by a respective interior space in the process block (base body).

On the process block base body, at least one component of the exposure device forming a functional component provided for the selective exposure of construction material layers to be selectively solidified can precisely be arranged or is precisely arranged. The at least one component of the exposure device can, e.g., be arranged on or attached to an exposed outer surface of the process block base body. As a component of the exposure device, e.g. an energy beam generation device and/or a beam deflection device and/or at least one optical element, especially a filter element, an objective element, or a lens element, of the exposure device can be arranged or is arranged on the process block base body. Respective components of the exposure device can also be attached to the process block base body by at least one respective assembly component.

On the process block base body, (also) at least one component of the exposure device forming a functional component provided for forming construction material layers to be selectively solidified in a construction plane of the apparatus can precisely be arranged or is precisely arranged. The at least one component of the exposure device can, e.g., be arranged on or attached to an inner surface of the process block base body limiting the process chamber. As a component of the coating device, a guiding device for a coating element having an, especially blade-shaped, coating tool, and/or a coating element having an, especially blade-shaped, coating tool can be arranged or is arranged on the process block base body. Respective components of the coating device can also be attached to the process block base body by a respective assembly component.

In addition, on the process block base body at least one component of a detection device forming a functional component of the apparatus, provided for (optical) detection of at least one detection variable especially regarding a process-relevant (physical) parameter, such as atmosphere, pressure, temperature, melting pool geometry, etc., can precisely be arranged or is precisely arranged. The at least one component of the detection device can also, e.g., be arranged on or attached to an inner surface of the process block base body limiting the process chamber. As a component of the detection device, e.g., an optical or thermal detection element, especially an optical or thermal camera, can be arranged or is arranged on the process block base body. Respective components of the detection device can also be attached to the process block base body by a respective assembly component.

On the process block base body, a powder module limiting a powder reception room can further precisely be arranged or is precisely arranged. The powder module can form a bottom end of the process block base body. The powder module can especially be a construction module in the powder reception room (construction room) of which the actual additive manufacturing of three-dimensional objects is carried out.

In order to realize an oscillation decoupling of the process block from the housing construction, between the process block and the housing construction at least one attenuation or oscillation decoupling element can be arranged or formed. Typically, for a sufficient oscillation decoupling, several attenuation or oscillation decoupling elements are to be connected between the process block and the housing construction. A respective attenuation or oscillation decoupling element can, e.g., be formed as an elastic or viscoelastic element, especially as an elastic spring element or viscoelastic elastomer element.

A guiding device can be assigned to the process block. The guiding device can be provided to move the process block into an operating position, in which the process block is arranged within the housing construction, and into a non-operating position, in which the process block is arranged outside the housing construction, and vice versa. It is also conceivable that the guiding device is provided to move, i.e. possibly also to turn, the process block into several defined positions within the housing construction. A respective guiding device can comprise suitable, e.g. rail-like or rail-shaped, guiding elements, along which the process block can be moved, e.g. between the operating position and the non-operating position. By providing a respective guiding device, e.g. assembly, repair, or service tasks of the apparatus can be simplified.

The process block can at least comprise a connecting element, e.g., for connecting an external (electric) energy or inert gas supply for the functional components arranged or formed on or in the process block. The process block can thus form a (widely) self-sustaining functional unit.

In addition to the apparatus, the invention also relates to a housing construction for an apparatus for additive manufacturing of three-dimensional objects by successive, selective layer-by-layer exposure and thus solidification of construction material layers of a construction material that can be solidified by means of an energy beam, wherein within the housing construction several functional components of the apparatus can be arranged or formed. At least one housing wall of the housing construction is formed as a sheet metal part or comprises at least one sheet metal part. The explanations above in connection with the housing construction associated with the apparatus apply analogously.

The invention is explained in more detail by means of exemplary embodiments in the figures of the drawings. In which:

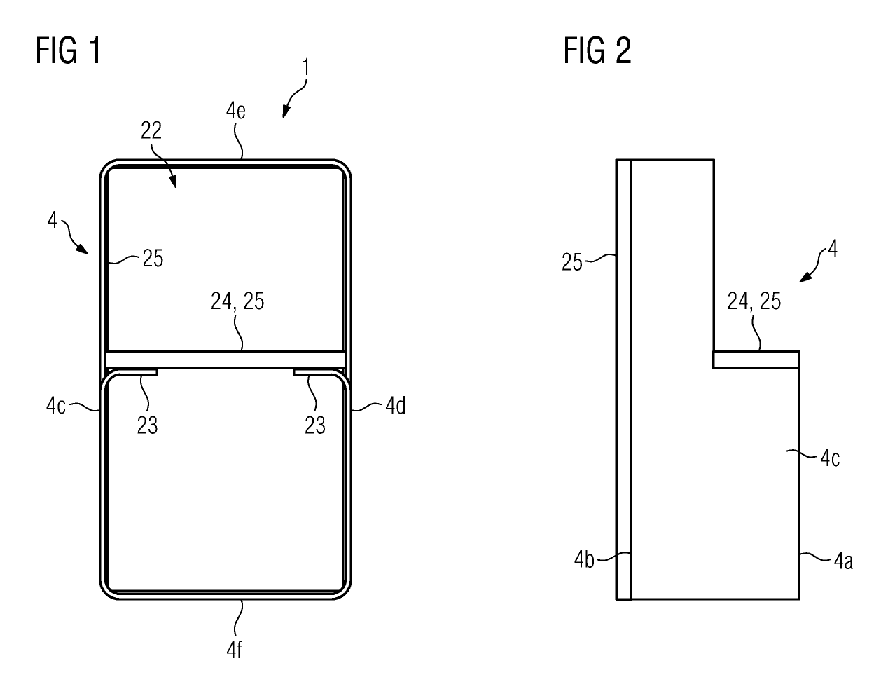

FIGS. 1, 2 each show a schematic diagram of an apparatus according to an exemplary embodiment;

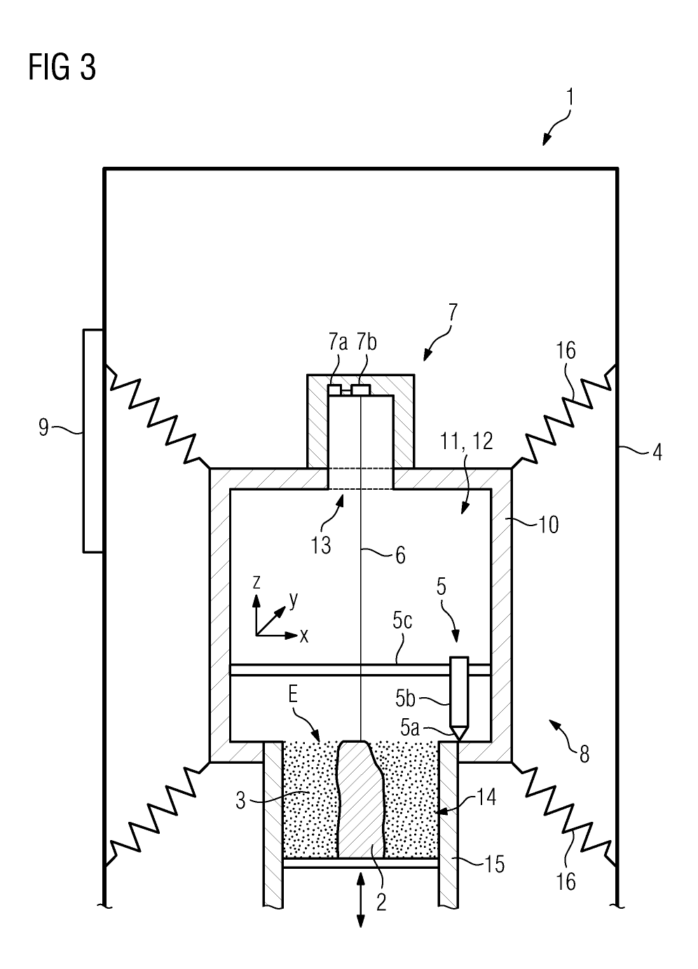

FIG. 3 shows a schematic diagram of an apparatus according to a further exemplary embodiment; and

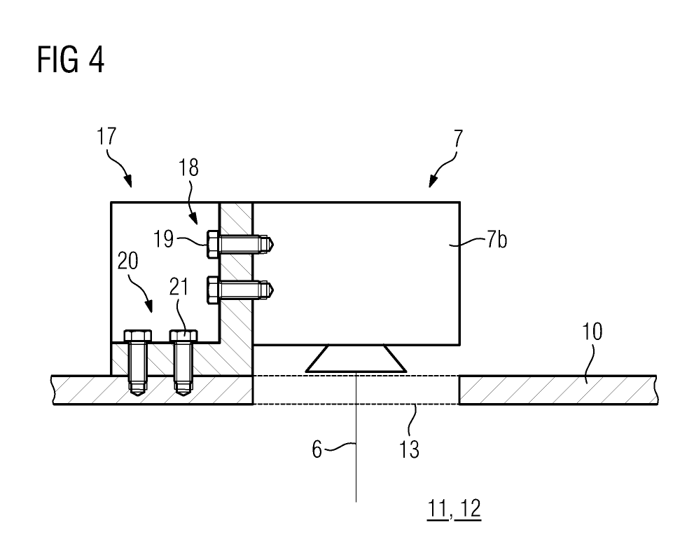

FIG. 4 shows a schematic diagram of an assembly state of a functional component of the apparatus according to an exemplary embodiment.

FIGS. 1, 2 each show a schematic diagram of an apparatus 1 according to an exemplary embodiment. In FIGS. 1, 2, only that detail of the apparatus 1, i.e. especially of the housing construction 4 associated with the apparatus 1, is shown that is relevant for the discussion of the principle described in the following. In FIG. 1, the apparatus 1 is represented in a front view and is represented in FIG. 2 in a side view rotated by 90°.

The apparatus 1 serves the additive manufacturing of three-dimensional objects 2 (cf. FIG. 3), i.e. especially technical components or technical component groups, by successive, selective layer-by-layer exposure and thus successive, selective layer-by-layer solidification of construction material layers of a construction material 3, i.e., for example, a metal powder, which can be solidified by means of a laser beam 6. The selective solidification of respective construction material layers to be solidified is carried out based on object-related construction data. Respective construction data describe the geometric or geometric-structural design of the respective object 2 to be additively manufactured and can, for example, include “sliced” CAD data of the object 2 to be manufactured. The apparatus 1 can be formed as a Laser-CUSING® apparatus, i.e. as an apparatus for performing selective laser melting methods.

The apparatus 1 comprises an outer housing construction 4. The housing construction 4 forms a (closed) housing or covering construction of the apparatus 1 and thus (essentially) defines the outer design of the apparatus 1.

The housing construction 4 comprises several housing walls 4a-4f. The housing walls or the housing wall portions limit a housing construction interior space 22. In the housing construction interior space 22, several functional components of the apparatus are arranged or formed, i.e., for example, a process chamber 12, the coating device 5 typically arranged in the process chamber 12, and the exposure device 6 typically arranged or formed on the process chamber 12.

The housing walls 4a-4f in the example of an (essentially) cuboid-like or cuboid-shaped housing construction 4, i.e. a housing construction having an (essentially) quadrangular base or cross-sectional shape, shown in the Figures are a front wall 4a forming a front side of the housing construction 4, a rear wall 4b arranged opposite said front wall, forming a rear side of the housing construction 4, a first side wall 4c extending (rect)angularly between the front and rear walls 4a, 4b, a second side wall 4d arranged opposite the first side wall 4c between the front and rear walls 4a, 4b, extending (rect)angularly to those, a ceiling wall 4e, and a bottom wall 4f.

The housing walls 4a-4f are formed by sheet metal parts. The housing construction 4 thus comprises no frame construction comprising several profile-like frame construction elements attached to each other, but consists of sheet metal parts.

Evidently, the sheet metal parts have a plane geometric-structural design. Specifically, the sheet metal parts have a quadrangular or rectangular geometric-structural plane design. The dimensions of the sheet metal parts are selected in terms of the dimensions of the housing walls 4a-4f formed by them; consequently, the dimensions of the sheet metal parts correspond to the dimensions of the housing walls 4a-4f, respectively, formed by them.

The sheet metal parts can be formed of a steel sheet or a stainless steel sheet. The wall thickness (thickness) of a respective sheet metal part is in a range between 1 and 10 mm, especially between 2 and 6 mm. It is conceivable that a sheet metal part has sheet metal part portions of different thicknesses; this way, the structural properties of the sheet metal part can specifically be affected.

The structural properties of the sheet metal parts allow a supporting function for the housing construction 4. It is basically not necessary to provide further supporting constructional elements for forming the housing construction. In FIGS. 1, 2, an optional and partial reinforcement of the sheet metal parts or the housing construction 4 by suitable (mechanical) reinforcement or stiffening elements that is described further below is (mechanically) shown.

A sheet metal part can be a stamped part/bent part that in manufacturing terms can be manufactured comparatively simply. Stamped parts/bent parts can be manufactured with narrow tolerances in almost any geometric-structural design.

In terms of the forming of a sheet metal part as a bent part, it applies that the sheet metal part can be bent two- or three-dimensionally.

From FIGS. 1, 2 it can be seen that a sheet metal part can comprise several sheet metal part portions, especially (rect)angular to each other. A first sheet metal part portion can form at least one part of a first housing wall 4a-4f or a first housing wall 4a-4f. and another sheet metal part portion can form at least one part of at least one other housing wall 4a-4f or at least one other housing wall 4a-4f. Related to the (significantly) cuboid-like or cuboid-shaped design of the housing construction 4, a respective sheet metal part portion can form at least one part of the front and/or side and/or rear walls of the housing construction 4. From FIG. 1 it can be seen that, e.g., the ceiling wall 4e, the side walls 4c, 4d, and the bottom wall 4e can be integrally formed of a sheet metal part bent multiple times. In general, sheet metal parts can, e.g., have an angular base shape, i.e., for example, an (essentially) L- or U-shaped base shape. To this extent, a housing wall 4a-4f formed of a sheet metal part can also comprise several housing wall portions, especially angular to each other, wherein a respective housing wall portion forms at least one part of the front, side, rear, ceiling, or bottom walls of the housing construction 4.

The sheet metal parts can comprise one or more attachment interfaces (not shown), which are provided for attaching a functional component to the respective sheet metal part. Basically, respective attachment interfaces can enable a form-locked and/or force-locked and/or substance attachment of a functional component to the sheet metal part.

Sheet metal parts adjacently arranged can directly be attached to each other in a form-locked and/or force-locked and/or substance attachment manner. The attachment of respective sheet metal parts to each other can thus be carried out by form-locked and/or force-locked and/or substance attachment types enabling a detachable attachment (in a damage-free and non-destructive manner) or a non-detachable attachment of respective sheet metal parts (in a damage-free and non-destructive manner). Reference to riveting attachments, clamp attachments, screw attachments, or push-in attachments as examples for form-locked and/or force-locked attachment types, and to adhesive joints, soldered joints, or welding joints as examples for substance attachments is only made exemplary.

Sheet metal parts adjacently arranged can also be indirectly, i.e. by interconnecting at least one assembly component (not shown), be attached to each other in a form-locked and/or force-locked and/or substance attachment manner. The sheet metal parts can each be attached to the assembly component and thus to each other in a fixed and stable arrangement and orientation. The assembly component can, e.g., be formed as assembly block or an assembly bracket.

As mentioned, it can be required to (mechanically) reinforce or stiffen the sheet metal parts or the housing construction 4 by suitable (mechanical) reinforcement elements or stiffening elements. A respective sheet metal part can thus be formed with a reinforcing structure or stiffening structure (not shown), especially in the form of a bead structure comprising at least one bead.

A reinforcement or stiffening of the sheet metal parts or the housing construction 4 can alternatively or complementary also be realized by a reinforcement frame 25 assigned to the housing construction 4. The reinforcement frame 25 can be arranged or formed outside and/or inside the housing construction 4. The reinforcement frame 25 at least partially abuts on the sheet metal part to be reinforced or to be stiffened or abuts on the housing wall 4a-4f to be reinforced or to be stiffened. The reinforcement frame 25 can be a component (group) serving the reinforcement or stiffening of sheet metal parts or the housing construction 4.

In the exemplary embodiment shown in FIGS. 1, 2, on the sheet metal parts forming the housing walls 4c, 4d attachment interfaces in the form of flaps 23 are shown, on which a plate element 24 forming a user working surface is attached. The plate element 24 serves as an (additional) reinforcement frame 25 to (additionally) reinforce or to stiffen the housing construction 4.

Further, it is conceivable that the or a reinforcement frame 25 is formed by a portion of a control cabinet construction (not shown), in which electrical and/or electronic components of the apparatus 1 are arranged or formed. For example, a housing construction of the control cabinet can (additionally) serve to reinforce or to stiffen the housing construction 4.

It is also conceivable that the or a reinforcement frame 25 is formed by an, especially plate-like, process chamber wall element (not shown) limiting the process chamber 12 at the bottom, laterally, and at the ceiling. For example, the process chamber wall element laterally limiting the process chamber 12 can serve to reinforce or to stiffen the housing construction 4. This can be realized by the process chamber wall element at least partially extending along a housing wall 4c, 4d. A process chamber wall element limiting the process chamber 12 at the bottom and comprising a construction plane can serve to reinforce or to stiffen the housing construction 4 by being arranged or formed directly between two housing walls arranged opposite each other. This analogously applies to a process chamber wall element limiting the process chamber 12 at the ceiling.

FIG. 3 shows a schematic diagram of an apparatus 1 according to another exemplary embodiment in a sectional view.

In FIG. 3, the functional components required for performing additive construction processes are schematically shown. They include the coating device 5 provided for forming construction material layers to be selectively solidified (in the construction plane of the apparatus 1) and the exposure device 7 provided for the selective exposure of construction material layers to be selectively solidified (in the construction plane of the apparatus 1). The coating device 5 typically comprises several components, i.e., for example, a coating element 5b comprising an, especially blade-shaped, coating tool 5a, and a guiding device 5c for guiding the coating element 5b along a defined trajectory. The exposure device 7 also comprises several components, namely a beam generation device 7a for generating a laser beam 6, a beam deflection device 7b for deflecting the laser beam 6 generated by the beam generation device 7a to a section to be exposed of a construction material layer to be selectively solidified, and various optical elements (not shown), such as filter elements, objective elements, lens elements, etc., which are typically arranged between the beam generation device 7a and the beam deflection device 7b.

The apparatus 1 comprises a process block 8 arranged within the housing construction 4. Evidently, the functional components of the apparatus 1 mentioned are arranged on and/or in the process block 8. The process block 8 thus comprises one or more attachment interfaces (not denoted in more detail), which are provided for attaching at least one functional component to the process block 8. Respective attachment interfaces can enable a form-locked and/or force-locked and/or substance attachment of a functional component to the process block 8. An attachment interface enabling a force-locked attachment of the functional component to the process block 8 can, e.g., be or comprise a bore, especially a threaded hole, which can be penetrated by a screw element. Eligible form-locked attachment types are, e.g., clip attachments or locking attachments; eligible substance attachments are, e.g., adhesive joints, soldered joints, or welding joints. Apart from possible user or operating interfaces (not shown), such as an operating device 9 communicating with a control device (not shown) controlling the operation of the functional components for performing additive construction processes, e.g. in the form of a touch panel, and/or connecting elements (not shown), e.g. for connecting an external (electric) energy supply for certain functional components, no functional components are arranged or formed on the housing construction 4.

The process block 8 along with the functional components arranged or formed on and/or in it constitutes (regarding the housing construction 4) a separate, i.e. movable especially independently of the housing construction 4, construction unit; evidently, in the exemplary embodiment the process block 8 thus forms no component of the housing construction 4. The process block 8 is especially arranged within the housing construction 4 such that it or the functional components arranged or formed on and/or in it are in no contact with the housing construction 4; between the process block 8 or the functional components arranged or formed on and/or in it and the housing construction 4, there is no direct mechanical contact in the exemplary embodiment. The process block 8 or the functional components arranged or formed on and/or in it are thus mechanically decoupled from the housing construction 4. Possible forces, vibrations, etc. brought into the housing construction 4 cannot be transferred to the process block 8 or the functional components arranged or formed on and/or in it, which is positively affecting the operation thereof.

The functional components arranged or formed on and/or in the process block 8 are arranged on and/or in it in a positioning that can exactly be defined or is defined, i.e., arrangement and/or orientation. The process block 8 forms the reference system for the defined spatial arrangement of the functional components arranged or formed on and/or in it. For this purpose, the process block 8 has defined process block axes (x-, y- and z-axes) forming an, e.g. Cartesian, coordinate system of the process block 8. In geometric-structural terms, the process block 8 is a comparatively simply built constructional unit—specifically the process block 8 can, e.g., be a milling part—which can be manufactured with narrow tolerances with comparatively low effort. Respective narrow tolerances are required to use the process block 8 as a reference system for an accurate positioning of the functional components.

The process block 8 comprises a process block base body 10. In the exemplary embodiment, the process block base body 10 comprises one or more walls or wall portions (not denoted in more detail) partially (rect)angular to each other, limiting an interior space 11. The interior space 11 of the process block base body 10 forms the (inertable) process chamber 12 being a functional component. The process chamber 12 is thus formed in the process block 8.

On the process block base body 10, the components, i.e. the laser beam generation device 7a, the beam deflection device 7b, and the optical elements of the exposure device 7 are further precisely arranged. In the exemplary embodiment, the components of the exposure device 7 are arranged or formed on an exposed outer surface of the process block base body 10 formed by an upper wall of the process block base body 10 provided with an opening 13 for the laser beam 6.

On the process block base body 10, the components, i.e. the coating tool 5a, coating element 5b, and the guiding device 5c of the coating device 5 are further also precisely arranged. In the exemplary embodiment, the components of the coating device 5 are arranged or formed on an inner surface of the process block base body 10 formed by a wall limiting the interior space 11 or the process chamber 12.

In addition, on the process block base body 10 (also) components (not shown) of a detection device forming a functional component of the apparatus 1, provided for (optical) detection of at least one detection variable especially regarding a process-relevant (physical) parameter, such as atmosphere, pressure, temperature, melting pool geometry, etc., can precisely be arranged or are precisely arranged. The components of the exposure device can, e.g., also be arranged on or attached to a respective inner surface of the process block base body 10. As a component of the detection device, e.g. an optical or thermal detection element, especially an optical or thermal camera, can be arranged or is arranged on the process block base body 10.

On the process block base body 10, a powder module 15 limiting a powder reception room 14 is further precisely arranged. The powder module 15 forms the bottom end of the process block base body 10. The powder module 15 is a construction module in the powder reception room 14 (construction room) of which the actual additive manufacturing of three-dimensional objects 2 is carried out.

The process block 8 as well as the functional components arranged or formed on and/or in it can form an assembly that can be preconfigured or is preconfigured and separately manageable. Thus it is possible to equip the process block 8 with certain functional components and in such a way form an assembly that is preconfigured, separately manageable, i.e. especially transportable.

In order to realize an optional oscillation decoupling of the process block 8 from the housing construction 4, in the exemplary embodiment, there are attenuation or oscillation decoupling elements 16 arranged or formed between the process block 8 and the housing construction 4. A respective attenuation or oscillation decoupling element 16 can, e.g., be formed as an elastic or viscoelastic element, especially as an elastic spring element or viscoelastic elastomer element. Respective attenuation or oscillation decoupling elements 16 are optionally present.

The process block 8 can be assigned with a guiding device (not shown). The guiding device is provided to, e.g., move the process block 8 into an operating position, in which the process block 8 is arranged within the housing construction 4, and into a non-operating position, in which the process block 8 is arranged outside the housing construction 4, and vice versa. It is also conceivable that the guiding device is provided to move, i.e. possibly also to turn, the process block 8 in several defined positions within the housing construction 4. A respective guiding device can comprise suitable, e.g. rail-like or rail-shaped, guiding elements, along which the process block 8 can be moved between different positions, e.g. between the operating position and the non-operating position.

The process block 8 can at least comprise a connecting element (not shown), e.g. for connecting an external (electric) energy or inert gas supply for the functional components arranged or formed on or in the process block 8. Respective connecting elements can, e.g., be arranged or formed on the process block base body 10.

Basically, the functional components can directly or indirectly, i.e. by interconnecting at least one assembly component 17 (cf. FIG. 4), be arranged on and/or in the process block 8.

FIG. 4 shows a schematic diagram of an assembly state of a functional component of the apparatus 1 according to an exemplary embodiment.

In FIG. 4, the case of an indirect attachment of a functional component is shown; here, a beam deflection device 7a is exemplified as a component of the exposure device 7. The functional component is attached to the process block 8 via an assembly component 17 attached to the process block 8 or the process block base body 10. The functional component is attached in a fixed and stable arrangement and orientation to the assembly component 17; the assembly component 17 is attached in a fixed and stable arrangement and orientation to the process block 8. The assembly component 17, which can, e.g., be formed as an assembly block or assembly bracket, has narrow tolerances such that the functional component attached to the process block 8 via said block or bracket is accurately positioned.

The assembly component 17 comprises at least one first attachment interface 18 provided for attaching the functional component in a fixed and stable positioning to the assembly component 17. In the exemplary embodiment the first attachment interface 18 enables a force-locked attachment of the functional component to the assembly component 17. Specifically, the first attachment interface 18 comprises several bores (not shown), especially threaded bores, which can be penetrated by a screw element 19. The assembly component 17 further comprises at least one second attachment interface 20 provided for attaching the assembly component 17 in a fixed and stable positioning to the process block 8. In the exemplary embodiment, the second attachment interface 20 also enables a force-locked attachment of the assembly component 17 on the process block 8. Specifically, the second attachment interface 20 also comprises several bores (not shown), especially threaded bores, which can be penetrated by a screw element 21.

Although the positioning of the functional component on the assembly component 17 or the positioning of the assembly component 17 on the process block 8 is fixed and stable, it can, as seen by means of the screw attachments, be detachable (in a damage-free and non-destructive manner).

1. An apparatus (1) for additive manufacturing of three-dimensional objects (2) by successive, selective layer-by-layer exposure and thus solidification of construction material layers of a construction material (3) that can be solidified by an energy beam (6), comprising an outer housing construction (4) comprising several housing walls (4a-4f), wherein within the housing construction (4) several functional components of the apparatus (1) are arranged or formed, characterized in that at least one housing wall (4a-4f) is formed as a sheet metal part or comprises at least one sheet metal part.

2. The apparatus according to claim 1, characterized in that all housing walls (4a-4f) of the housing construction (4) are formed as sheet metal parts.

3. The apparatus according to claim 1, characterized in that a sheet metal part comprises several sheet metal part portions, especially angular to each other, wherein a first sheet metal part portion forms at least one portion of a first housing wall (4a-4f) and at least one other sheet metal part portion forms at least one portion of at least one other housing wall (4a-4f).

4. The device according to claim 1, characterized in that the or a respective sheet metal part is a stamped part/bent part.

5. The device according to claim 1, characterized in that the or a respective sheet metal part is formed of a steel sheet.

6. The device according to claim 1, characterized in that the or a respective sheet metal part is formed with a reinforcement structure, especially in the form of at least one bead.

7. The device according to claim 1, characterized by a reinforcement frame (25) assigned to the housing construction (4), wherein the reinforcement frame (25) is arranged or formed outside and/or within the housing construction (4), wherein the reinforcement frame (25) at least partially abuts against at least one metal sheet part to be reinforced.

8. The device according to claim 7, characterized in that the reinforcement frame (25) is formed by a portion of a control cabinet construction, in which electrical components of the apparatus (1) are arranged or formed, or a plate element (24) forming a user working surface of the apparatus (1) or an, especially plate-like, process chamber wall element limiting a process chamber (12) of the apparatus (1) is formed at the bottom, laterally, and at the ceiling.

9. The device according to claim 1, characterized in that at least two sheet metal parts adjacently arranged are attached to each other in a form-locked and/or force-locked and/or substance attachment manner.

10. The apparatus according to claim 1, characterized by a process block (8) that can be arranged or is arranged as a separate construction unit within the outer housing construction (4), wherein on and/or in the process block (8) several functional components of the apparatus (1) are arranged or formed in a defined spatial arrangement and/or orientation, wherein the process block (8) forms the reference system for the defined spatial arrangement of the functional components of the apparatus (1) arranged or formed on and/or in said process block.

11. The apparatus according to claim 10, characterized in that the process block (8) and the functional components of the apparatus (1) arranged or formed on or in said process block form an assembly that can be preconfigured or is preconfigured and separately manageable.

12. The apparatus according to claim 10, characterized in that the functional components of the apparatus (1) arranged on the process block (8) are attached on the process block (8) via an assembly component (17) that can be attached or is attached on the process block (8), wherein the functional components are attached on the assembly component (17) in a fixed and stable arrangement and orientation, and the assembly component (17) is attached on the process block (8) in a fixed and stable arrangement and orientation.

13. The apparatus according to claim 10 characterized in that the process block (8) comprises a process block base body (10), wherein the process block base body (10) limits the process chamber (12) of the apparatus (1).

14. The apparatus according to claim 10 characterized in that the process block (8) comprises a process block base body (10), wherein at least one component of an exposure device (7) forming a functional component of the apparatus (1), which is provided for the selective exposure of construction material layers to be selectively solidified, can be precisely arranged or is precisely arranged on the process block base body (10).

15. The apparatus according to claim 10 characterized in that the process block (8) comprises a process block base body (10), wherein at least one component of a coating device (5) forming a functional component of the apparatus (1), which is provided for forming construction material layers to be selectively solidified in a construction plane (E) of the apparatus (1), can be precisely arranged or is precisely arranged on the process block base body (10).

16. The apparatus according to claim 10 characterized in that the process block (8) comprises a process block base body (10), wherein at least one component of a detection device forming a functional component of the apparatus (1), which is provided for (optical) detection of at least one detection variable, especially regarding a process-relevant parameter, can be precisely arranged or is precisely arranged on the process block base body (10).

17. The apparatus according to claim 10, characterized in that the process block (8) comprises a process block base body (10), wherein a powder module (15) limiting a powder reception room (14) can precisely be arranged or is precisely arranged on the process block base body (10).

18. The apparatus according to one of claims 10, characterized in that between the process block (8) and the outer frame construction (4) at least one oscillation decoupling element (16) for oscillation decoupling the process block (8) from the outer frame construction (4) is arranged or formed.

19. The apparatus according to claim 10 characterized by a guiding device assigned to the process block (8), wherein the guiding device is provided to move the process block (8) into an operating position, in which the process block (8) is arranged within the outer housing construction (4), and into a non-operating position, in which the process block (8) is arranged outside the outer housing construction (4).

20. A housing construction (4) for an apparatus (1) for additive manufacturing of three-dimensional objects by successive, selective layer-by-layer exposure and thus solidification of construction material layers of a construction material (3) that can be solidified by an energy beam (6), wherein within the housing construction (4) several functional components of the apparatus (1) can be arranged or formed, characterized in that at least one housing wall (4a-4f) is formed as a sheet metal part or comprises at least one sheet metal part.
